(19) United States
(12) Patent Application Publication
(10) Pub. No.: US 2005/0221937 A1
(43) Pub. Date: Oct. 6, 2005

(54) Transmission unit provided with a swash plate (variants) and differential speed converter (variants) based thereon

(76) Inventors: Stanovskoy Victor Vladimirovich, Tomsk (RU); Remneva Tatyana Andreevna, Tomsk (RU)

Correspondence Address: SHERMAN D PERNIA, ESQ., PC, 1110 NASA ROAD ONE, SUITE 450, HOUSTON, TX, 77058-3310, US

(21) Appl. No.: 10/495,150

(22) PCT Filed: Nov. 13, 2001
(86) PCT No.: PCT/RU01/00478

§ 371 Date: May 10, 2004

(51) Int. Cl. F16H 55/12; F16H 55/14

(52) U.S. Cl. 474/163; 475/168

(57) ABSTRACT

A transmission and speed conversion device is provided with a wobble (presessional) plate. The transmission unit has two cases encompasing each other. The first case is embodied as a wobble plate in that it is capable of two independent motions: rotation and pressession around its own axis which is inclined with respect to the axis of the second case. The adjacent side surfaces of the two cases are embodied in the form of a shperical belt, the center of the sphere being disposed at the center of precession of the wobble plate. Race grooves are embodied on the adjacent case surfaces and communicate with each other via rotation bodies. The race grooves are inclined to each other where they contact the rotation bodies at an angle less than the self blocking angle of the wobble plate, allowing the device to operate in such a way that the rotation bodies are slip-free. The device can be provided with a system of angular races parallel with each other, and can operate as a friction-planetary transmission in which pressure is automatically regulated by load.

### BACKGROUND OF THE INVENTION

1. Field of the Invention

The invention relates to motion transmitting devices of the general mechanical engineering, namely, to means for transfer of rotation with the transformation of speed based on the mechanism with wobble (precession) plate, and may be used in drives of general use machines and mechanisms.

2. Description of the Related Art

The converters of speed named and classified in according any aspects, but based on an identical principle of a tooth gearing with a wobble plate are known.

Wave gear end-to-end transfer concerning to that is described in patent application of the Russian Federation N^{o} 940023896, MIIK F16H1/00. Transmitting unit of this gear contains a wobble plate with a face gear ring which is in driving engagement with face plate of fixed cogwheel. The precession of the wobble plate is caused by wave actuator embodied as the eccentric with a pressure roller. The wobble plate is connected to output shaft by universal joint. In according to the same kinematics are constructed a cone planetary precession gear (SU the USSR N^{o} 1414976), wave gear with rigid parts (SU N^{o} 653458), cone wave gear (RU N^{o} 2145016). Similar kinematics, but with distinctions in embodiment of separate units are realized in speed transducers described in patents of USA: U.S. Pat. Nos. 3,525,890; 3,640,154; 4,281,566; 4,841,809; 5,562,560. Some of them have two transmitting units, i.e. realize two-stage gear. All speed transducers above described have common disadvantages resulting from tooth engagement. At first, this is high friction and high thermal losses especially under high speed of rotation. Furthermore, only some few of teeth can be kept in driving engagement in transmitting devises mentioned above thereby limiting torque capacity.

Some of these disadvantages are eliminated in the speed transducers with nutation or precession system of torque transfer with cam driving engagement of transmitting parts by means of rolling bodies (U.S. Pat. No. 4,715,249; U.S. Pat. No. 4,563,915; SU N^{o} 1427115). The differential speed converter with a wobble plate (U.S. Pat. No. 4,563,915) has transmitting unit composed of three members. The wobble plate has a cam element associated therewith and having axially directed cam lobes. The patent further discloses that the lobes engage rollers which are constrained to move along the surface of an imaginary sphere; however, since the crests of the axially directed cam lobes are at slightly greater distance from center of the imaginary sphere than the valleys, and since the rollers are at a fixed distance, the rollers will be forced to disengage and reengage with the cam surface causing wear, noise and undesirable reciprocating forces. Said disadvantage is eliminated in devices described in patents U.S. Pat. No. 4,620,456 and U.S. Pat. No. 5,443,428. Transmitting unit in these devices also includes three members, one of which is the wobble plate, and other two members are formed as solids of revolution. The wobble plate is intermediate part and provided at least with one cam surface formed as the bent groove being in driving engagement by means of balls with a cam at one of said solids of revolution. In the device of U.S. Pat. No. 4,620,456 side surface of a wobble plate is bent by sphere, and the trochoidal groove is located in a place of intersection of the lateral and the face surfaces, or at the face surface of a wobble plate. At an opposite end face of a wobble plate in one-stage converter the set of slots being in engagement with the slots of solid of revolution by means of balls is located. The solids of revolution are individually connected to output shaft and to the housing of the converter accordingly. For fixing angular position of balls from each other during running simultaneously over the edges or hollows of conjugated grooves there is a thin-walled separator between conjugated surfaces, in apertures of the separator said balls are located. In a two-stage converter there are epitrochoidal grooves with different numbers of tooth at two opposite end faces of a wobble plate, which grooves are conjugated with hypotrochoidal grooves located at the housing component and at the output component.

Precession of the plate occurs relative to the centre of precession, being the centre of symmetry of the system, and so the files of balls make nutation movement because of their centers are displaced from the centre of precession. Balls make oscillatory movement, both in axial, and in a radial direction, that is during the operating of the mechanism a changing of an angle of displacement of engaged members occurs, resulting in vibration and in problems caused by it, namely noise and deterioration for high-speed mechanisms. Furthermore, the grooves being an epitrochoid and hypotrochoid are difficult in manufacturing. Understanding of it causes the authors to propose manufacturing of all components of the transfer mechanism of plastic, thereby allowing production of grooves of the complex form by punching. It is obvious, that such transfers are not suitable for power mechanisms, and may be used only for apparatuses, watches etc. products.

In patent U.S. Pat. No. 5,443,428 there is described the converter of the same design but with even more difficult in calculation and manufacturing cam periodic surface. The patent employs engaging elements with undulating surfaces, but the surfaces are all designed to be spherically directed so that only angular displacement of the various elements is encountered thus avoiding translational vibrations as well as disengagement and reengagement problems. This transmission eliminates sliding contact thereby minimizing frictional losses, binding and other sources of inefficiency, wear and noise. However, each file of balls makes the complex movement superposed of precession relative to point of intersection of plane of said file and axis of system and of planetary motion relative to axis of converter. That is relative to this axis balls make radial movements thereby keeping an opportunity of noise and vibrations. Furthermore special requirements to the form of cam surfaces do the converter hardly applicable in power drives of general use and manufacturing.

There is known a speed converter (U.S. Pat. No. 1,748,907), transmitting unit of which consists of two members: male spherical head and female wobble plate. On an internal spherical surface of a wobble plate along an equatorial line hemispherical recesses are located in which the same number of balls are fixedly seated. These balls are in turn in engagement with a continuous curved groove formed in spherical head. As the wobble member nutates, the balls successively incite the head to move rotationally by engaging the walls of the groove. In this transmitting unit the center of precession of ball file is coincident with center of precession of the wobble plate, therefore the ball file will be participate only in precession, thereby reducing exacting requirements to the form of groove. The main disadvantage of the converter is significant frictional losses caused by sliding contact of balls with recesses in wobble plate

The decision of a problem developing transmitting unit in which rollers contact with periodic grooves only by means of pure rolling, without a sliding friction, is the object of the invention described in application WO008201043, chosen by us as a prototype of one variant of transmitting unit. The motion transmitting unit comprises a male member and a female member, both made in the form of solids of revolution with meshing elements between them. In a simple construction the meshing elements may be n balls where n is a multiple of four, the balls meshing in a wavy groove having (n−1) or (n+1) waves in the male member, and the balls engaging also in n arcuate grooves in the female. The grooves of male and female members are made at part-spherical conjugated surfaces of the members. In this application transmitting unit is composed of two members arranged so that one embraces the other, one of which is a case and the other is wobble element (swash plate). The differential speed transducer on the basis of this transmitting unit comprises the first shaft, second shaft and the frame. The swash plate is coupled to one of said shafts by coupling means transforming swashing movement in rotary, and swash plate is coupled to other of members by second coupling means transmitting the rotation of the swash plate independently of its swashing movement. Pure rolling motions of balls in grooves of male and female members are achieved in two ways. Firstly, in transmitting unit with meridian slots, said slots are located at female member, thereby compensating different ways passable by a ball relative to inclined front of a wave in the circumferential groove and relative to meridian slot by means of a difference in the distance from contact points of a ball with a male and female members up to the centre of sphere.

The second way is an altering the cross-section of the grooves in the male and female members thus causing the balls to rise and fall in the grooves to alter the effective radial point of contact, thus altering the ratio and thus achieving equal constant instantaneous rolling velocities of the balls on the surfaces of the male and female elements. Thus, in both ways the purpose is achieved by alignment of a way, passable a ball relative to both groove for same time. However, as have shown our researches, it is not enough this condition to force balls to interact with grooves only by rolling with the exception of sliding.

Furthermore, the prototype, as well as each of the above described speed converters with a wobble element, has the fixed housing to which quite concrete detail is connected in each concrete design, and transmitting unit has the internal volume limited to the housing. The converter with the own housing, as a rule, is not built in drive mechanism and so placed and packed outside, thereby increasing dimensions of the device as a whole. Thus, an object of the invention is the creation of universal transmitting unit which is simple in manufacturing, minimal in specific weight and sizes characteristics and convenient for building in the machines and mechanisms, and also the creation of a speed converter based on it.

The condition of pure rolling of balls discovered by us appeared suitable not only in transmitting units with periodic grooves. Its application in ball friction-planetary transmitting units has allowed creating the whole class of the elementary transmitting mechanisms which are devoid the main disadvantage of all friction gears, namely, occurrence slippage with wear process of details. Transmitting unit of known ball friction-planetary gears (SU N^{o} 844863, SU N^{o} 1229484, and RU N^{o} 2010141) comprises two solids of revolution with grooves, and separator placed between the spherical surfaces of said solids of revolution. In sockets of separator some rolling elements being balls are located. One of solids of revolution is connected to input shaft, another is connected to the frame or to other shaft, and the separator which transforms orbital movement of balls to rotation of an output shaft is connected to the shaft. With simplicity of a design, the basic problem of friction-planetary ball gears is necessity of the pressure mechanism which prevents slippage of balls under increasing of the torque or as a result of deterioration of balls and grooves while in service. Press mechanisms, basically, use various elastic elements.

The technical result of the present invention is elimination of sliding or skidding motion between the balls and the walls of the grooves in transmitting unit with a swash plate. Thus for friction-planetary ball gears the problem of automatic control of pressing a ball without application of special mechanisms is solved.

The transmitting units according to this invention are a basis not only for differential speed converters, but they also may have independent application for example in mixers. According to this invention it is possible to develop the mechanism for direct transformation of oscillatory energy (for example, energy of sea waves) to energy of rotation with the increased or reduced speed of rotation. The additional technical result achievable by individual variants of the invention is the design in the form of bearing unit free of the stationary housing; instead any member becomes fixed one when setting this unit to its workplace.

It is simpler to understand the substance of the invention with consideration an example of transmitting unit with a wobble plate in friction-planetary ball gear; therefore we shall start the description by this embodiment of the invention.

### SUMMARY OF THE INVENTION

According to the invention, torque transmitting unit comprises two members in the form of solids of revolution. One said solid of revolution is arranged to make two independent movements: wobbling relative to another and rotation around of the own axis inclined with respect to axis of other solid of revolution and so may be designated as a wobble (precessional) plate. On the adjacent surfaces of said case and wobble plate endless grooves are made interacting with each other by means of rolling bodies being in continuous contact with grooves of both members. The tilting angle of the wobble plate is chosen so that the grooves in a place of contact with rolling body are inclined to each other by angle less or equal to the self-blocking angle of rolling body. In practice this angle for usual constructive materials may be accepted in a range of 0,1-10 degrees. If the above condition is catered for, the rolling bodies, for example being balls, are pressed between surfaces of a wobble plate and the second member, therefore rotation one said member forces balls in orbital movement relative to another member without slippage. Orbiting balls just as cams push wobble plate causing it to precess. Thus, transmitting unit with a wobble plate realizes a principle of friction-planetary ball gear in which planetary movement of a ball is transformed to precession of said wobble plate and vice versa.

With this configuration, said angle of grooves inclination to each other provides automatic adjustment of pressing a ball between them, since under increasing of load or deterioration of a ball and grooves, the ball is displaced along of azimuth in area of smaller distance between grooves.

For range extension of gear ratio, the cross sections of grooves have to be in such form that zones of contact of rolling body with the walls of grooves lay at different distances from rotation axis of a rolling body.

Transmitting unit with a wobble plate according to the invention may be embodied in two constructive modifications: disk-shaped and coaxial. In the first modification the solids of revolution are formed as disks, one of which wobbles relative to another. The annular endless grooves are arranged at the flat surfaces of disks faced to each other and are in contact with rolling body located between this grooves. To meet a condition of groove inclination to each other by angle less than angle of self-blocking, the tilt angle of a wobble plate with respect to axis of transmitting unit should be within the limits of 0,2-15 degrees. Then the rolling body itself is established in that place of a circle of grooves where the distance between the grooves meets to the size of the rolling body.

If the rolling body is a ball, the side walls of a groove at any of disks preferably to be resilient flexing to each other. Thus the radius of curvature of a groove cross section becomes variable; the point of the ball contact with a groove will be displaced from an axis of a ball rotation under load variation. Thus, the transmitting unit is capable to vary gear ratio depending on loading automatically.

In the coaxial modification of the transmitting unit the solids of revolution are embodied so that one will embrace the other, one of them is wobble plate and the other is a case, both having side surfaces faced to each other in the form of spherical zones with the centre of sphere being in the centre of precession of a wobble plate. Generally, each groove in a wobble plate and in a case is realized as a set of closed annular grooves parallel with respect to each other, lying in planes perpendicular to axis of rotation of the appropriate member. The rolling bodies are the balls located in points of intersections of the wobble plate grooves with the case grooves.

In particular cases, in the wobble plate the set of grooves constitutes single groove lying in an equatorial line of the wobble plate and intersecting with one or several grooves in the case. Single groove in the case is displaced from equatorial circle of sphere by the distance equal to half of oscillation amplitude of the wobble plate and is engaged with a groove of the wobble plate by means of single ball.

To balance the set of balls relative to the case axis, two annular grooves are located at the different sides of the large circle of sphere by distances equal to half of oscillation amplitude of the wobble plate. Annular grooves in the case are engaged with a groove in the wobble plate by means of two diametrically located balls. The same balanced system of balls is achieved if the case have single groove in the line of large circle of sphere with the balls located at two diametrically opposite points of intersection this groove with a groove in the wobble plate.

Integration of two above described variants in one design is possible. Then three grooves are located in the case, one being in the line of the large circle of sphere and two being on both sides of this larger circle at distances equal to half of oscillation amplitude of the wobble plate. In engagement with this grooves are four balls located in pairs diametrical opposite points in mutually perpendicular diameters.

Also, it is possible the combination of one groove in an equatorial plane of the case with two grooves in the wobble plate spaced apart of an equatorial line by the distances equal to half of oscillation amplitude of the wobble plate.

The grooves in the case may be located at separate and independently rotating annular case parts. It will be noted that in all above described constructions, there is necessarily to meet the condition producing to the angle of a grooves inclination to each other. Unless the above condition is catered for, a slippage of balls occurs thereby upsetting their frictional communication with grooves and failing torque transfer.

The second variant of the invention is realized in transmitting unit with a wobble plate provided with circumferential wavy grooves. For achievement of the technical result mentioned above, this transmitting unit, as well as the prototype, contains a case and a wobble plate embodied so that one will embrace the other. Their side conjugated surfaces are in the form of spherical zones with the centre of sphere lying in the centre of the wobble plate precession. Periodic in azimuth direction grooves are made in equatorial area of the conjugated surfaces of the case and the wobble plate faced to each other. At least one of said grooves is formed as endless and wavy bent in an axial direction one. The grooves are engaged with each other by means of the balls located in intersections of grooves. In contrast to the prototype, grooves in a place of contact with balls are inclined to each other by angle less to an angle of self-blocking of balls. This condition is met, if angle α of a periodic groove front inclination to equator of the wobble plate and the appropriate angle β at the case are in the following ratios to the wobble plate tilt angle γ:
α−β−Γ≦?10, at α≧?; (1)
β−δ+γ≦?10, at α<β; (2)

Angles α and β both depend on number of the periods and on amplitude of appropriate grooves. Amplitudes, in turn, are connected to the tilt angle of a wobble plate. In any case, by way of varying these values it is possible to achieve performance of conditions (1) and (2).

In comparison with the prototype, in our invention the condition of a choice of the groove period numbers is changed also. The number of balls n may be anyone. However, with a small amount of balls (within the limits of 10-20) for achieving of the counterbalanced system of balls it is desirable that the number of balls is even. Number of the periods of grooves N1 and N2 in the wobble plate and in the case accordingly are in the following ratios to number of balls n: N1=kn±1; N2=qn±1, where k and q are integers or numbers of a kind 1/m where m is the number by which a number of balls is divided without the rest. Expansion of a range of possible numbers N1 and N2 not only provides expansion of a gear ratio range for one transmitting unit with the certain number of balls, but also increases number of combinations of the groove periods at which the condition of self-blocking of balls is satisfied. It will be noted, that the friction-planetary transmitting unit of a coaxial configuration described above is, as a matter of fact, the particular case with the groove period numbers N1=0 and N2=1.

Periodic grooves on both members may be closed wavy bent. The groove in one of members can be made interrupted in the form of system of slots spaced over the circle and extended along of meridians of sphere.

In the next embodiment for increasing of unit functionalities, the case is slit along an average line of the bent groove thereby forming two independently rotating parts of the case. The groove on each of parts represents system of the half waves with different number of the periods.

The differential speed converter on the basis of the above described transmitting units comprises three shafts. The wobble plate of transmitting unit is connected to one of shafts by means of mechanism for independent transformation of its precession motion into rotation of a shaft and on the contrary. Moreover, the wobble plate is connected to second of shafts by means of the mechanism transferring its rotation about an inclined axis irrespective of its wobbling. The second solid of revolution is directly connected to the third shaft.

For ball friction-planetary transmitting units of disk configurations the mechanism for transformation of a wobble plate precession into rotation of a shaft and on the contrary is embodied as the face cam cooperating with a wobble disk through the bearing, and the second shaft is the frame of the transmitting unit and is connected to a wobble plate by means of the device preventing rotation of the last.

For coaxial transmitting units it is expedient to make all shafts coaxial and hollow whereby forming a coaxial design composed of cases like bearing unit.

The converter with transmitting unit, in which the case consists of independently rotating parts, is supplied with additional shafts which are directly connected to the said parts.

As the mechanism for independent transformation of precession of a wobble plate into rotary movement of the first shaft and on the contrary may serve skew crank shaft on which the wobble plate is set by bearing. Also, as the mechanism for transformation of precession in rotary movement may serve any friction-planetary ball transmitting unit of coaxial design realized on the same wobble plate at its side opposite to the basic transmitting unit. Then the case of the friction-planetary unit serves as the first shaft of the converter.

The mechanism of independent transferring a wobble plate rotation to the second shaft may be embodied as gimbals joint, as a system of flexible rods and hinges, or as a bevel gear.

Transmitting units of coaxial design allow creating two-stage speed converters without significant increase of dimensions. The stages of transmitting units are located in series along the same axis or are arranged that one embraces the other (coaxial design of two-stage speed converter). The two-stage converter of coaxial design, in turn, may be made by two variants. In the first variant of coaxial design the transmitting units of both stages use the same wobble plate. For this purpose, at the wobble plate of the first stage transmitting unit at side opposite to this unit, the transmitting unit of the second stage is arranged, i.e. the whole system is formed of three elements in series embracing one another: case, wobble plate, case. The second stage transmitting unit in this variant serves as the mechanism transferring the rotation of the wobble plate to the converter shaft connected directly to the case of the second stage transmitting unit. As the mechanism transferring wobble plate precession into rotation and on the contrary no all above described means may be used because of some of them use the second side of a wobble plate which side in this variant is occupied with the second transmitting unit. For this variant the special mechanism is developed representing two hollow shafts, entered by means of bearings between internal and external cases at opposite end faces. Each of shafts is made with an identical skew crank. The wobble plate is set on both crank shafts by means of bearings. The hollow shafts may be made with the face cams cooperating with wobble plate end faces through thrust bearing.

In a second variant, the two-stage converter is consisted of two separate transmitting units embracing each other. Wobble plates of both units are faced to each other. The mechanism transferring the precession of each of wobble plates into rotation represents a hollow shaft entered between wobble plates of both stage and having on both side surfaces faced to wobble plates the elements causing a precession of the wobble plates.

Elements causing a precession of wobble plates may be designed in form of skew cranks with an identical or opposite inclination. The wobble plates are set on said cranks by means of bearings. With an identical inclination of cranks the wobble plates oscillate synchronously, with opposite inclination of cranks they oscillate in the opposite phases. Elements causing a precession of wobble plates also may be made by another way. In each pair consisting of hollow shaft and wobble plate, annular groove and annular ledge interfaced with each other by means of two opposite balls are made on the lateral surfaces of said hollow shaft and wobble plate faced to each other. Balls are located between groove walls and a ledge at the opposite sides of the ledge. The wobble plates of both stages are connected with each other by means of unit transferring rotation, so that the transmitting unit of the second stage carries out the function of the mechanism transmitting the wobble plate rotation to a shaft directly connected to the case of second stage transmitting unit.

The two-stage speed converter may comprise two coaxial transmitting units located one after another along one axis. In this variant the wobble plates of both stages are connected by means of mechanism transferring rotation between parallel shafts. A mechanism transferring precession into rotation of a shaft is made the same as that for the one-stage converter and should provide synchronous precession of wobble plates. In the result, wobble plates during precession are parallel each other. This converter being similar externally to the two-stage converter described in the description to patent U.S. Pat. No. 5,443,428, nevertheless essentially differs from it in that the periodic grooves on both wobble plates are located in equatorial area. That is, the files of balls in both stages participate in precession about the point lying in a plane of a file of balls, and the nutational submotion is absent in the movement of balls. At that there is essential simplification of requirements to the form and working accuracy of grooves for full elimination of noise and vibrations.

The unit transferring the rotation between parallel shafts may be realized on base of any known circuits. For these purposes the mechanism with parallel cranks suits well. The most preferable from the point of view of reduction of losses by friction is the mechanism with parallel cranks with ball engagement, as, for example, presented in patents U.S. Pat. No. 4,829,851 or U.S. Pat. No. 4,643,047. Said unit may be realized also as a shaft to which each of wobble plates is connected by means of gimbals joint. For this speed converter the original mechanism for transformation of precession motion of wobble plates to rotary movement and on the contrary is developed. It includes a case located on an axis between stages of the converter; said case is supplied with an external annular ledge. The case is made with two parallel skew cranks on which the wobble plates are set by means of bearings. The annular ledge project from limits of external cases of both transmitting units, and its external profile is made in form of an element of worm, conic or a friction gear. Such mechanism transfers precession motion of plates to shaft, the axis of which is perpendicular to the general axis of transmitting units. That is, the speed converter is intended for rotation transferring between two skew shafts.

The two-stage speed converter with a sequential arrangement of stages may be made with the precession of plates in opposite phases. In this variant, wobble plates of both stages are connected by means of the mechanism transferring rotation between inclined shafts, and the mechanism transferring precession movement provides precession of plates in opposite phases. It is necessary to note, that the speed converters formed under the invention are effective only with small angle γ of inclination of a wobble plate. Otherwise, transferring of rotation between the details inclined to each other under the wide angle will need the mechanism which considerably decreases effect of absence slippage of balls in the most transmitting unit. At the same time, for some variants of transmitting unit the angle γ may appear wide enough to meet ratios (1) and (2). Transmitting unit with both cases being wobbles plates allows bypassing this contradiction. In this variant, the angle γ in the ratios (1) and (2) to be understanding as an angle of an inclination of wobble plates with respect to each other. At the same time, each of wobble plates has an inclination to an axis of transmitting unit twice less. Also this angle in the mechanism transferring the rotation accordingly decreases.

Such transmitting unit may be of a basis of set of various designs of differential speed converters with various functionalities. Generally, the differential speed converter contains at least three coaxial hollow shafts, forming a coaxial design composed of cases likewise bearing unit, and transmitting unit with two wobble plates. Wobble plates are connected to one of shafts by means of mechanism of independent transformation precession motion into rotary and on the contrary, and they are connected with other two shafts by units transferring rotation between inclined shafts.

It is possible to excite a precession of wobble plates in a mode of opposite phases. In this variant, the speed converter operates similarly to that with single wobble plate, but the angle of an inclination between the wobble plates determining angular characteristics of grooves will be equal to the sum of angles of precession of each plate. Such embodiment allows reducing an angle of precession of each wobble plate while keeping an angle of an inclination of plates to each other. It simplifies requirements to mechanisms transformation of precession motion of the plates to rotation of a shaft and improves conditions of their operation. At the same time, reduction of an angle of precession, i.e. an angle of an inclination of each plate to an axis of the converter, simplifies requirements to mechanism transferring rotation between inclined shafts, and allows transferring higher torque with other things being equal.

The mechanism of transformation of precession movement of wobble plates in this variant may be made in form of two coaxial hollow shafts connected with each other, one of which is located outside of an external wobble plate, and the other is located inside an internal wobble plate. In each pair composed of a hollow shaft and wobble plate a groove and annular ledge are made on their side surfaces faced to each other. Said groove and annular ledge are interacting by means of two balls oppositely located between walls of a groove and a ledge at opposite sides of the ledge. Balls in each pair are located so that wobble plates have opposite inclinations.

The same result can be achieved, if the surfaces of hollow shafts faced to wobble plates and connected with each other are provided with skewed cranks with an opposite inclinations and cooperating with wobble plates by means of bearings.

For expansion of functionalities of the converter, it is desirable the mechanism transferring precession motion of plates to rotation of a shaft to form as two separate elements independent from each other, each of which is connected to separate shaft of the converter. This converter has an additional input shaft. With an equality of phases and speeds of precession of the wobble plates (i.e. two input speeds), we have a zero speed at an output of the mechanism. With an opposite direction of input speeds, or with an opposite precession phases, the mechanism operates as the speed converter with two inputs and two outputs with a different ratios of their speeds.

### BRIEF DESCRIPTION OF DRAWINGS

The invention is illustrated by graphic materials in which are presented:

FIG. 1 is the schematic representation of the ball friction-planetary transmitting unit in disk embodiment;

FIG. 2 is a diagram illustrating interacting of grooves and balls in this unit by scanning;

FIGS. 3, 4, 5 and 6 show various embodiments of a groove structure for expansion of transfer ratio range;

FIG. 7 is a sectional view showing the speed converter with this transmitting unit;

FIGS. 8-19 illustrate various constructive variants of ball friction-planetary transmitting unit in coaxial version, at that FIGS. 8, 10, 12, 14, 16, 18 show the general view of variants of transmitting unit, and at FIGS. 9, 11, 13, 15, 17 and 19 are shown diagrams of interaction of their grooves and balls;

FIG. 20 illustrates the axial section of transmitting unit with periodic grooves;

FIG. 21 is a diagram, illustrating relation of tilt angle of a wobble plate, angles of an inclination of periodic groove wave fronts and an angle between the grooves in a place of contact to a ball;

FIGS. 22-27 are representation an explanatory diagrams of interacting of grooves and balls for different variants of transmitting unit. Diagrams at FIGS. 22 and 23 illustrate an opportunity of satisfying the angular condition by means of a choice groove period numbers while keeping an angle of an inclination of a wobble plate and amplitudes of grooves. Diagrams on FIGS. 24 and 25 illustrate the possibility of satisfying the angular condition by changing amplitude of grooves while keeping a number of the periods. And, at last, at diagrams 26 and 27 there is shown the way to achieve of satisfying the angular condition by changing an angle of an inclination of a wobble plate;

FIGS. 28 and 29 show the axial section and the diagram of interaction of grooves and balls, accordingly, for transmitting unit in which one of periodic grooves is made interrupted and composed of meridian slots spaced apart over the a circle;

FIGS. 30 and 31 represent the axial section and the diagram of interaction transmitting unit members with a case composed of two separate parts;

FIGS. 32, 33, 34, 35 represent the sectional view of differential speed converters with the coaxial transmitting unit differing by designs of mechanisms transferring precession motion of a plate into rotation of a shaft, and also, by units transferring rotation of a wobble plate irrespective of its wobbling (i.e. by units of transfer of rotation between inclined shafts);

FIGS. 36 and 37 represent the two-stage converter with transmitting units of each stage realized at single wobble plate. Converters differ from each other only by designs of the mechanisms transferring precession motion of a plate into rotation of a shaft;

FIGS. 38 and 39 represent two-stage converters consisting of two transmitting units embracing one another and differing from each other by the design of mechanism transferring precession motion into rotation of a shaft;

FIGS. 40, 41, 42, 43 are diagrams illustrating different embodiments of the two-stage converters with arrangement of stages in series.

FIG. 44 schematically illustrates transmitting unit with two wobble plates;

FIGS. 45, 46, 47 illustrate some embodiments of converters on the basis of transmitting unit of FIG. 44.

It will be noted that all versions of designs of the converter according to the invention are not limited to the mentioned figures.

### BEST MODE FOR CARRYING OUT THE INVENTION

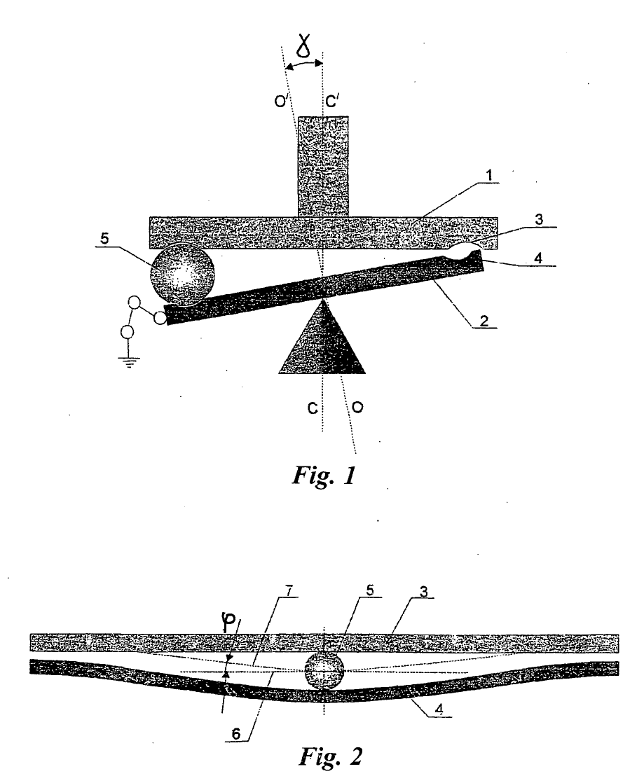

Transmitting unit in FIG. 1 contains two solids of revolution 1 and 2 in form of disks; circumferential closed grooves 3 and 4 are cut upon faced to each other surfaces of the discs. The disk 2 is capable to precess. For this purpose, its axis of rotation OO₁ is inclined to general axis CC₁ of transmitting unit, and the disk 2 rotates around of an own axis of rotation OO₁ and also wobbles relative to axis CC₁ irrespective of its rotation, i.e. the disk 2 is a wobble (precessional) plate. In contact with grooves 3 and 4 there is a rolling body 5; in this case it is a ball. FIG. 2 represents the diagram of interaction of a ball 5 with both grooves 3 and 4. The lines 6 and 7 represent the lines of movement of the centre of a ball 5 relative to disks 1 and 2 accordingly. The tilting angle γ of wobble plate 2 with respect to the disk 1 must to be such that the angle φ between grooves 3 and 4 in a place of their contact with a ball 5 did not exceed the angle of self-blocking of the ball. Self-blocking of rolling bodies is well known and is used in, so-called, free-wheel clutch (see, for example, Polyakov V. C., Barabash I. D. “Couplers”, L. “Mashinostroenie”, 1973, p.225). The angle of self-blocking is understood as the angle between two surfaces on which the rolling body is rolled up in a narrow part of a wedge due to frictional forces and is clamped between these surfaces. The angle of self-blocking of rolling bodies depends on factors of friction of a rolling body relative to grooves, which, in turn, depend on a material and on final polishing of rolling bodies and grooves surfaces.

As have showed our researches, it is expediently to choose the angle φ within a range of (0,1-10) degrees. However, sometimes, for example, for rolling bodies made of an elastic material or for grooves with a frictional covering, this angle may to lie within a range of 15-17 degrees. During a rotation of one of disks (for an example, a disk 1) relative to another disk, the ball 5 will roll up into a narrow part of a wedge between grooves 3 and 4. In contrast to free-wheel clutch, blocking of a ball in our transmitting unit will not take place, as a wobble plate 2 and a ball 5 both have two degrees of freedom. Under action of pressure of the ball 5 against the groove 4, the plate 2 will begin to wobble. The speed of planetary motion of the ball centre is twice smaller than speed of the point at the ball surface in a place its contact to the groove 3. Planetary movement of a ball will cause precession of a plate which angular speed is twice smaller than input speed of rotation, i.e. the transmission ratio of the unit is 2:1. Inclined position of a wobble plate 2 results in that the ball 5 is constantly pressed to a surface of grooves 3 and 4 without additional clamping mechanisms which are necessary in usual ball friction-planetary transmitting units. With increasing of load, or with deterioration of grooves, a ball 5 runs in narrower part of a wedge between grooves 3 and 4, thereby automatically increasing the pressing effort. Thus, transmitting unit operates without slippage of a ball since speed of planetary moving of the ball 5 is coordinated with speed of its rotation about an own axis. The tilting angle of a wobble plate is functionally related to an angle φ between grooves by a following equation:
tg γ=π/2tg φ,
i.e., when the angle φ is in the range of 0,1-10 degrees, the tilting angle of a wobble plate should be chosen in the range of 0,2-15 degrees.

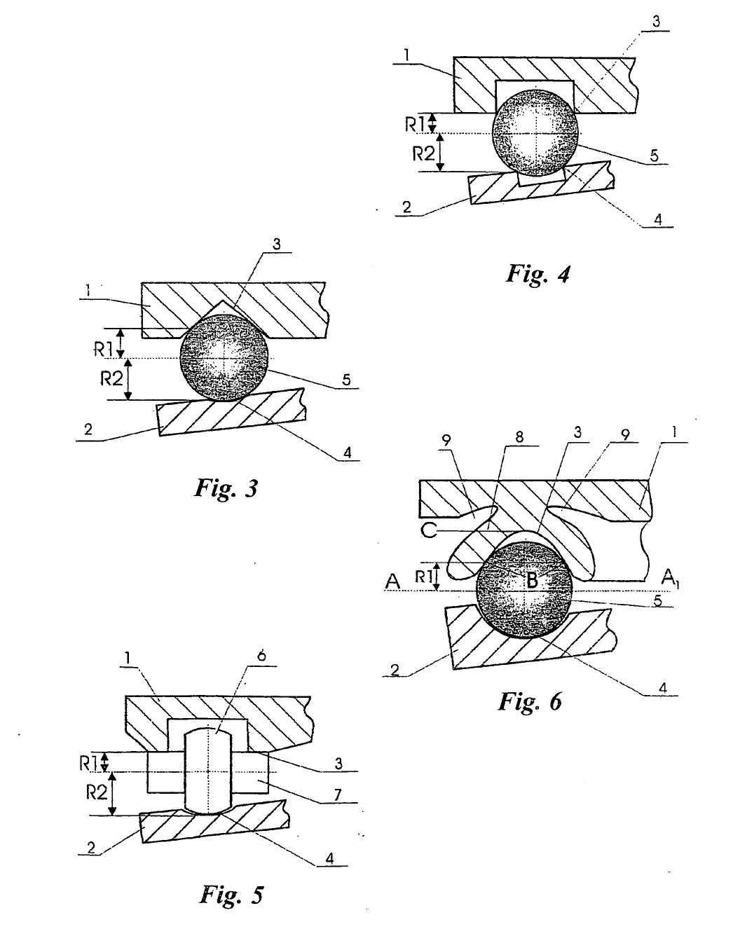

As well as in usual ball friction-planetary unit, it is possible to increase a range of transmitting ratio in above unit by changing effective rolling radiuses R1 and R2 of rolling bodies 5 in grooves 3 and 4 (see FIGS. 3, 4 and 5). For this purpose structures of cross section of grooves 3 and 4 are formed such that rolling radiuses of ball R1 and R2 in grooves 3 and 4 would be not identical. The transmission ratio i₁₂ from a disk 1 to a disk 2 is: i₁₂=1+R1/R2. FIGS. 5 illustrates the variant when the difference arises in result of applying of a rolling body in the form of the stepped roller contacting to grooves 3 and 4 by steps 6 and 7 having different diameters. FIG. 6 shows, how to make transmitting unit with automatic adjustment of torque value. The external annular part of any disk (in this case a disk 1) is embodied with a groove formed with resilient flexing walls 8. In other words, the cross section of groove may change a radius of curvature. At FIG. 6 the resilient flexing mobility of walls 8 is provided by means of two annular pinches 9. When increasing of the load at input shaft the ball 5 moves over circle in narrower part of a wedge between grooves thus unclenching walls 8 of groove 3 from each other. A point of the ball contact with the groove 3 moves from point B to point C thereby increasing effective rolling radius R1 of the ball 5 in the groove 3. This increase will cause increase of the transmission ratio and the torque.

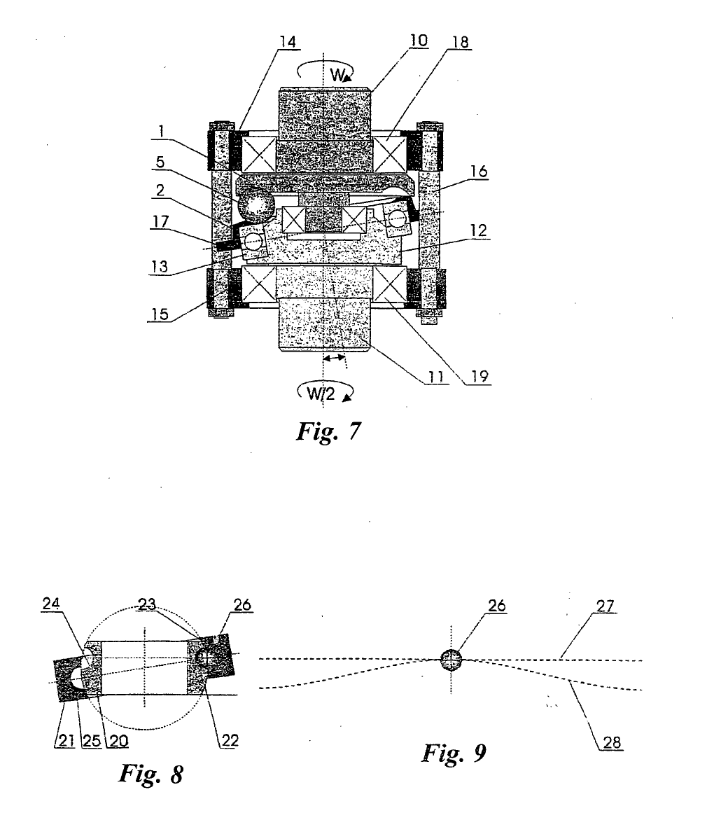

The differential speed converter with disk friction-planetary unit (see FIG. 7) contains a shaft 10 rigidly connected to a solid of revolution 1, and the shaft 11 connected to a wobble plate 2 by means of mechanism transferring its precession into the rotation of a shaft 11. The mechanism in this example represents the face cam 12 cooperating with a wobble plate 2 through bearing 13. The housing formed by two flanges 14 and 15 serves as the third part of the converter. The wobble plate 2 is connected to the flange 14 by means of unit preventing its rotation while permitting its wobbling. This unit is made in the form of rods 16 passing through apertures in a peripheral annular part 17 of wobble plate 2. Rods 16 pull together flanges 14 and 15 among themselves. Apertures for rods 16 in a wobble plate have the sizes admitting misalignments during wobbling of the plate. Shafts 10 and 11 are set in the housing flanges 14 and 15 by means of bearings 18 and 19.

Transmitting friction-planetary unit of coaxial embodiment contains a case 20 and a wobble plate 21 embracing one another. FIGS. 8, 10 and 12 show transmitting units in which the wobble plate 21 surrounds a case 20. It is necessary to note, that the inverted configuration of units when the wobble plate 21 is surrounded by a case 20 are quite efficient. Conjugated side surfaces 22 and 23 of the case 20 and of the plate 21 are the parts of sphere with the centre of sphere (point C) located in the centre of symmetry of both said details. The wobble plate 21 is arranged to have an opportunity of precession about a point C. In conjugated side surfaces 22 and 23 the grooves 24 and 25 are made. The groove 25 in the wobble plate 21 represents the annular flute cut in the line of equator of a wobble plate spherical surface.

The groove 24 is the annular groove shifted from an equatorial line of a spherical surface 22 for distance equal to half of oscillating amplitude of the plate 21. Both grooves in cross section have the form of a semicircle and in their intersection point the ball 26 is continuously contacting to both annular grooves. 27 and 28 are the sites of average lines of grooves 24 and 25 in lateral development.

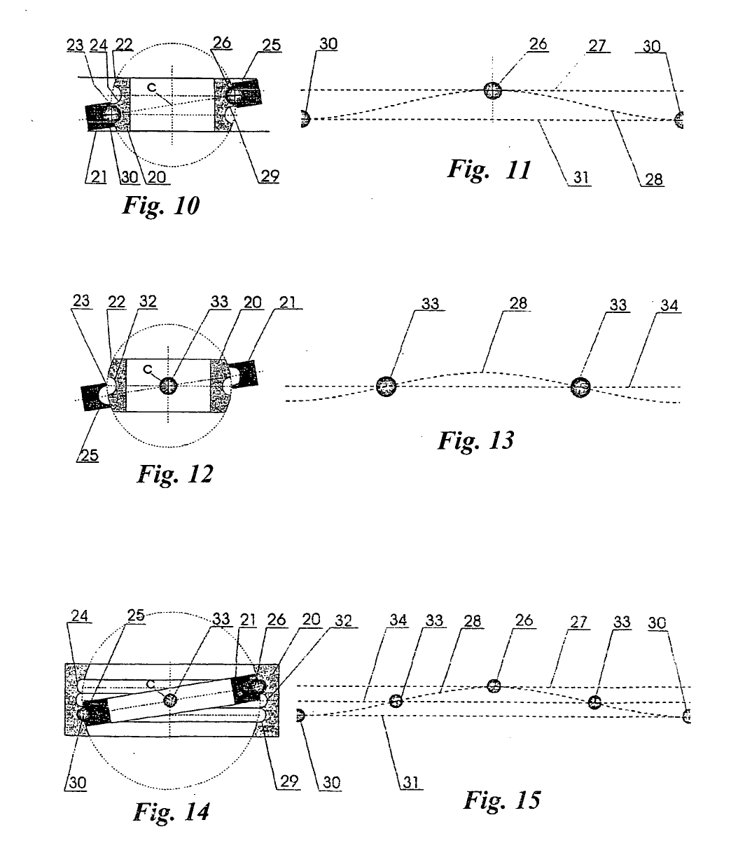

In other embodiment of this transmitting unit (FIG. 10) on a surface of a case 20 two symmetric parallel annular grooves 24 and 29 are made located at both sides from equator by distances from it equal to half of oscillating amplitude of the plate 21. At the intersections of grooves 24 and 29 with a groove 25 two balls 26 and 30 are located. At the diagram of FIG. 11 number 31 designates a centerline of a groove 29.

At FIG. 12 the groove 32 is located in the case 20 in line of its equator and engages a groove 25 in a wobble plate by means of two opposite balls 33 located in places of intersections of grooves 32 and 25. At FIG. 13 said places of intersections are the points of intersections of centerlines 28 and 34 of grooves 25 and 32.

Unit presented at FIG. 14 combines (into one) two previous embodiments. There are made three annular grooves 24, 29 and 32 parallel each other in surface of the case 20. Balls 26, 30 and two balls 33 are located in the grooves in places of their intersections with the groove 25 in a wobble plate. Here it is necessary to note, that the number of grooves on a surface of a case may be more than three, the main thing that they are parallel with respect to each other and lay in planes perpendicular to axis of rotation of the case 20, and balls should be located in places of intersections of these grooves with a groove 25 in the wobble plate. At the same time balls 33 which are engaged with a groove 32 in line of the equatorial circle of sphere are located in a circle of annular grooves in the antipodes. I.e. the system of balls is counterbalanced. The balls in other grooves are not counterbalanced; therefore for each groove located at one side of equator on this case it is expedient to make a symmetric groove at other side of equator.

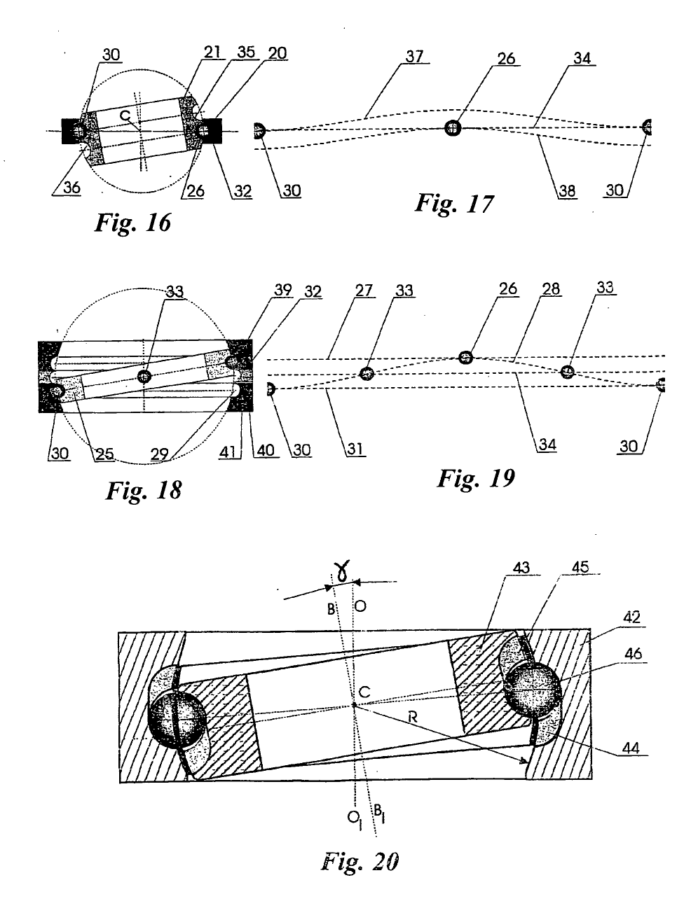

FIG. 16 shows the variant of unit in which there are two ring grooves 35 and 36 in a wobble plate, said grooves are located on the different sides from an equatorial line of a wobble plate by distance from it equal to half of the oscillating amplitude of the plate. The groove 32 in the case is cut in line of the equatorial circle of a spherical surface and is engaged with grooves 35 and 36 by two balls 26 and 30 located in places of intersections of centerlines 37 and 38 of grooves 35 and 36 with a centerline 34 of groove 32.

Basically, the variant with system of a few grooves in a wobble plate and system of few grooves in a case is possible. It increases a number of the balls cooperating with members the unit. The increase of the balls number distributes power streams among more number of cooperating elements and increases the maximum torque transmitted by means this unit with other things being equal.

The case 20 may be composed of separate rings 39, 40, 41, in each of which there is cut one groove (see FIGS. 18 and 19). Rings may rotate around of the common axis independently from each other. Such transmitting unit has the increase number of input and output elements thereby expanding its functionalities. Characteristic operate properties of converters with such transmitting units will be considered below.

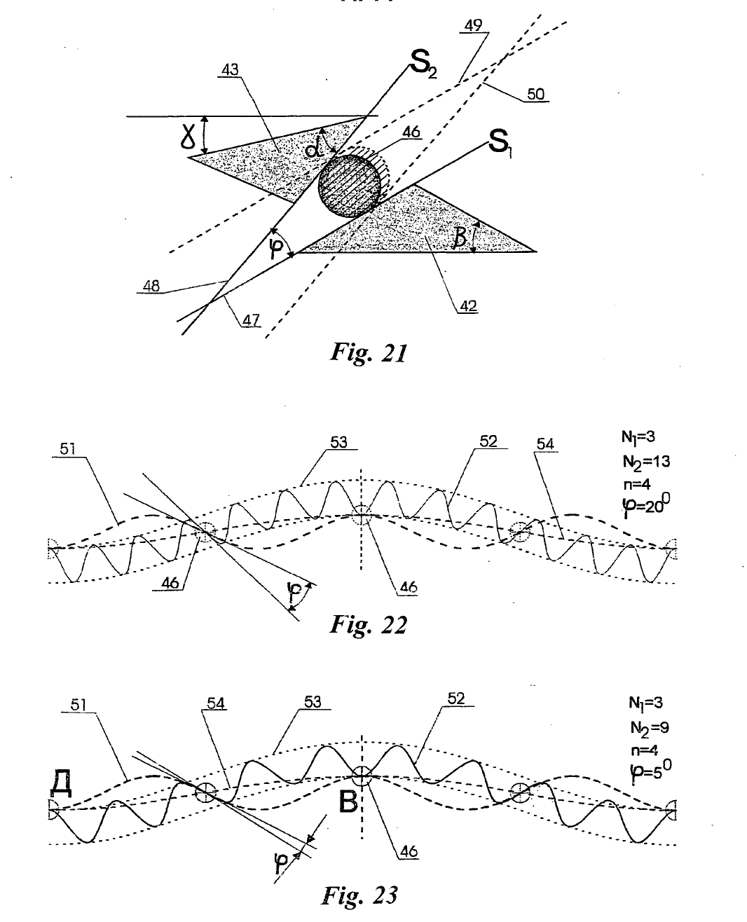

Transmitting unit with a wobble plate with periodic grooves represents two cases 42 and 43 where one case embraces the other. The case 43 is free to rotate around of axis BB₁ inclined to axis OO₁ of transmitting unit, and also to precess relative to a point C being the point of intersection of said axes. That is, the case 43 is a wobble plate. The faced to each other side surfaces of the case 42 and of the wobble plate 43 are parts a sphere of radius R with the centre of sphere in a point C. In equatorial areas of said surfaces periodic in azimuth direction grooves 44 and 45 are cut engaged each other by means of a file of balls 46. One or both grooves are made in the form of the closed flutes of semicircular cross section and are periodically bent in an axial direction. The tilting angle γ of the wobble plate 43 and also the form of periodic grooves 44 and 45 are chosen such that angles of an inclination of grooves with respect to each other in a place of their contact with rolling bodies 46 did not exceed the angle of self-blocking of rolling bodies. FIG. 21 is schematic representation of fronts 47 and 48 of grooves 44 and 45. During the one full wobbling of the plate 43 the file of balls 46 precess together with the wobble plate. At that, each ball interacts with the flange 48 of wave groove 45 and moves over circle relative to the case 42 by an angle corresponding to the period of the groove 45. At the same time balls 46 like cams press against front 47 of a wave groove 44 in the case 42 and cause its turning relative to a file of balls 46 by an angle corresponding to the period of a groove 44.

The total turn one case relative to another case for the full cycle of wobbling movement of the plate will occur by an angle equal to the sum or to the difference of these turns, depending on what front of groove balls will act. Thus, the transfer ratio i of the unit is determined by expression:
1/i=1/N₁±1/N₂ (3),
where N₁ and N₂ are the numbers of the periods of grooves 44 and 45 accordingly. Accomplishment of the angular condition results in being of each ball in wedge-shaped crack between two inclined surfaces S1 and S2 with the angle between them which is less than the angle of self-blocking of balls. During moving one of this surfaces, for example S2 relative to S1, (that corresponds to wobbling of the plate 43) balls 46 roll up in a narrow part of a wedge between surfaces S1 and S2 without slipping, and press against the front 47 of the wave groove 44, forcing it to turn, as it was described above. At the same time, frictional forces arising in result of rolling blocked ball and it interacting with one of surfaces cause said surface to turn relative to the file of balls. As far as the file of balls 46 and the wobble plate 43 both have two degrees of freedom, then running of balls and the moving of cases under action of frictional forces and pressure are coordinated with each other, i.e. balls will roll in wave grooves 44 and 45 without sliding.

In the patent application WO008201043, as a condition of pure ball rolling is accepted equating of a rolling distances passed by a ball relative to a groove 45 in the wobble plate 43 and relative to a groove 44 in the case 42. However, this condition is not sufficient. If the angle between grooves in a place of contact with balls is greater than the angle of self-blocking of balls (as it is represented on drawings and diagrams in disclosure of application WO008201043), then the ball will slip out of a wedge and will be kept in a place of intersection of grooves only by their opposite walls 49 and 50, i.e. the ball will be only a cam. At FIG. 21 the whereabouts of a ball in this variant is shown by means of shading. It is obvious, that in this case, a ball will be necessary to sleep relative to any of surfaces (47, 48, 49 or 50), and availability of greater area than the size of balls will cause their beating and the increased deterioration.

The tilting angle φ of grooves to each other depends on tilting angles δ and β of fronts 47 and 48 of grooves 44 and 45 to equatorial lines of the case 42 and the wobble plate 43 accordingly, and also the angle φ depends on tilting angle γ of a wobble plate, and is determined as:
Φ=α−β−γ, if α≧? (4) or
φ=β−α+γ, if α<β (5)

As it was shown above, for usual constructional materials the angle of self-blocking lays within the limits of (0,1-10)°, therefore the condition φ<10° (6) should be satisfied. In general, angles α and β depend on amplitudes of a bend and on number of the periods of grooves. Numbers of periods N₁ and N₂ of grooves in the case 42 and in the wobble plate 43 accordingly are depend on each other because the integer of the periods should be stacked on the same circle of the radius R. In the description of application WO008201043 it is specified, that numbers of the periods of grooves should differ from number of balls by unit, and from each other by two, thus the number of balls should be multiple of four. Our researches have shown, that number of the groove periods N₁ and N₂ and number of balls n are connected by ratio: N1=kn±1; N2=qn±1, (7) where k and q are integers, or they are numbers of a kind 1/m where m is the number by which the number of balls is divided without the rest. The number of balls as already it was told earlier may be anyone.

Thus, in our version, from all variety of combinations of numbers N₁ and N₂ satisfying to condition (7), it is necessary to choose such at which the inequality (6) is satisfied. FIGS. 22 and 23 illustrate an opportunity to achieve reduction of an angle φ by means of changing N₁ and N₂. Numerals 51 and 52 designate average lines of grooves 44 and 45 in the case 42 and in the wobble plate 43 accordingly. 53 is a line on which a point of a wobble plate surface moves during precession. Numeral 54 shows a motion path of balls 46. Amplitude of grooves and tilting angle of a wobble plate 43 are identical in both figures. In the first version, when N₁=3, N₂=13 and n=4 angles between grooves exceed angles of self-blocking, at least, in two positions of balls 46. At FIG. 23 average lines of grooves 51 and 52 are intersecting by angles less than the angle of self-blocking at all positions of balls 46. Period numbers of grooves and a number of balls are accordingly three, nine and four.

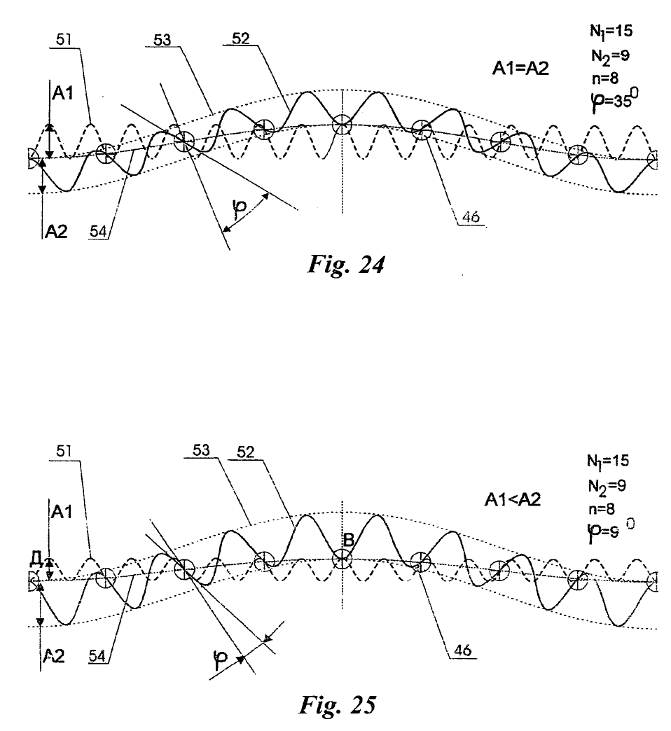

It is possible also to adjust an angle φ by changing of groove amplitudes, or by changing tilting angle of a wobble plate while keeping groove period numbers. These situations are illustrated at FIGS. 24, 25, 26 and 27. At FIGS. 24 and 25 there are shown the average lines 51 and 52 of grooves having the numbers of the periods fifteen and nine, and number of balls is eight. Minimal angle of grooves intersection at first of this figures exceeds 10 degrees, i.e. it is more than the angle of self-blocking. At FIG. 25, with decreasing of amplitude A1 of a bent groove in the case 42, maximal angle of groove intersection does not exceed the angle of self-blocking. In this version, all balls 46 will operate in a mode of self-blocking, i.e. without slippage.

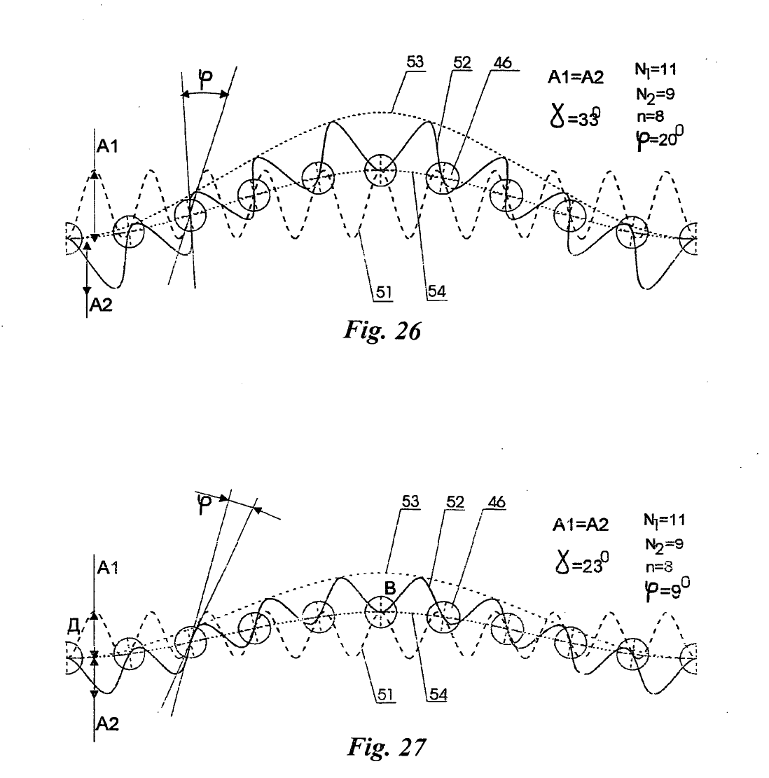

FIGS. 26 and 27 differ of each other only by the tilting angle φ of the wobble plate 43. It is obvious, that in transmitting unit at FIG. 27 the condition (4) is satisfied, and balls will move without slippage.

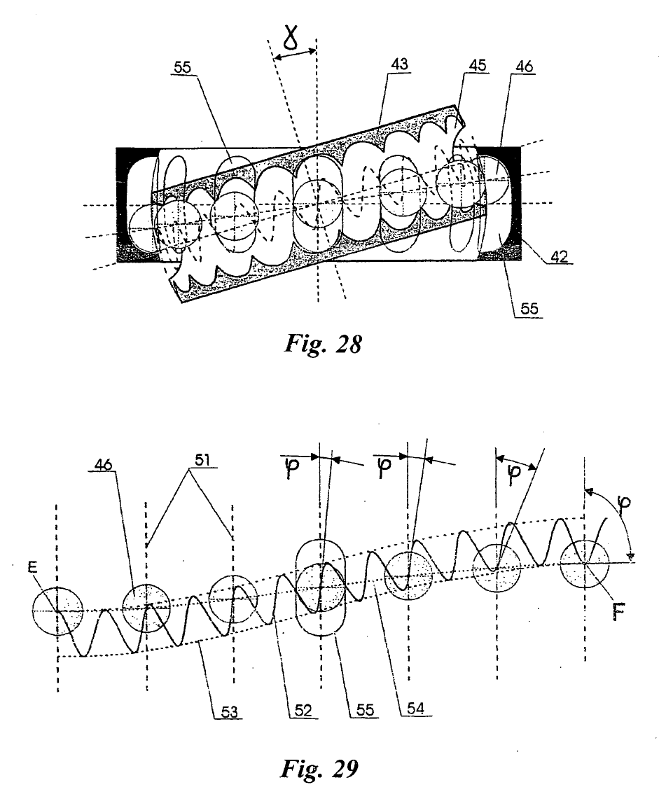

The groove in one of cases may be made interrupted. At FIG. 28 the periodic groove in the case 42 is formed as the system of the slots 55 spaced apart along of circles in a spherical surface. Each slot is located in meridian line of sphere. At FIG. 29 as well as on the previous figures, numerals 51 and 52 designate average lines of the appropriate grooves. It is obvious, that such transmitting unit will operate without slippage of balls 46 with very abrupt front of a bent groove 45 while with small tilting angles of a wobble plate 43, since the appropriate condition in this variant is transformed to expression φ=90°−α+Γ<10°. At that, the condition of pure rolling will be satisfied not for all balls 46. For the balls located in points E and F the condition of self-blocking is impracticable at any values of α, β or γ. Thus, as against the statement in the description of application WO008201043 that the unit with meridian slots in female detail will operate without slippage, we assert that individual balls in this design will slip. If the interrupted groove is made in the wobble plate 43, and the closed groove is in the case 42, the appropriate angular condition φ=90°−β−γ<10° expands opportunities for a choice of angles β and Γ, however seasonings about slippage of balls in points E and F are kept in force also for this variant.

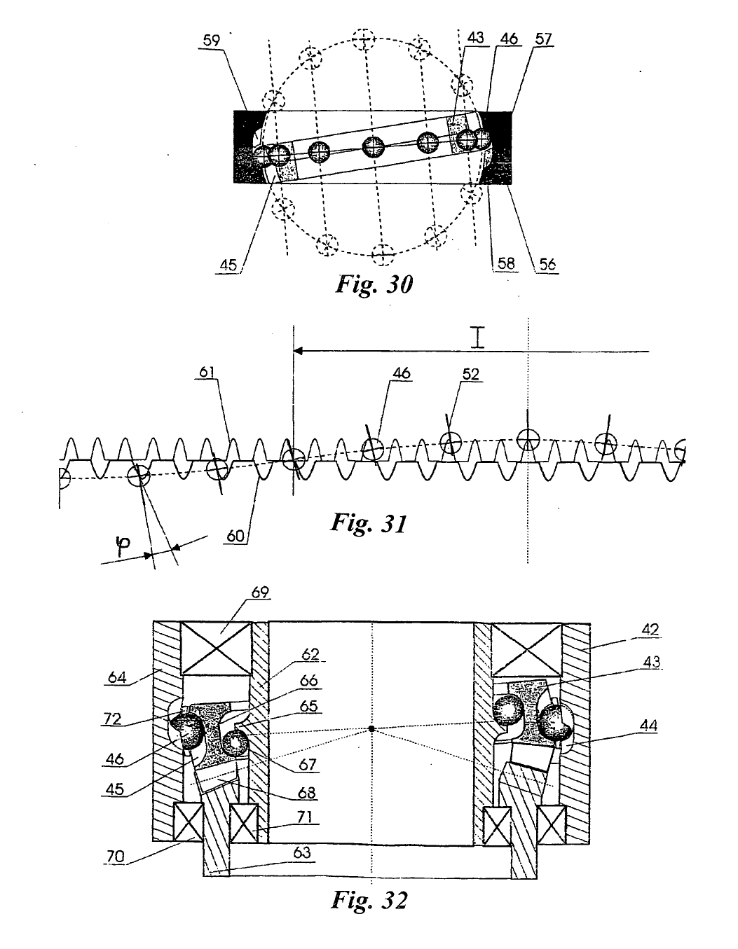

In transmitting unit at FIG. 30 file of balls 46 cooperates simultaneously with three periodic grooves. The groove 45 in the wobble plate 43 is interrupted and is made in the form of slots spaced apart along of circle. The case is composed of two individual independently rotating parts 56 and 57 having identical diameters and snap-together by their end faces. In internal side surfaces of these cases in a circle of their end face contact the periodic grooves 58 and 59 having different periods are made. On the diagram of FIG. 31 average lines of grooves 58 and 59 are designated by numerals 60 and 61. By numeral 52 is designated an average line of a periodic groove 45 in the wobble plate 43. In this embodiment of transmitting unit, the groove 45 is made interrupted. It is obvious that not all balls 46 will cooperate with cases 56 and 57 simultaneously. The balls located on the left and on the right of zone I at FIG. 31 will interact with the case 56, and balls located in zone I will interact with the case 57. The gear ratio of the unit depends on a proportion of period numbers of all three grooves that expands a range of the gear ratio.

Let us consider now speed converters including the above described transmitting units. The speed converter at FIG. 32 is realized with transmitting unit having the closed periodic grooves in the case 42 and in the wobble plate 43. The speed converter comprises three coaxial hollow shafts 62, 63 and 64. The shaft 62 is connected to the wobble plate 43 by means of mechanism transferring the rotation of a shaft 62 into wobbling movement of the plate 43. Said mechanism represents annular ledge 65 made on an external side surface of the shaft 62 and conjugated to annular groove 66 in the wobble plate 43. Between opposite walls of the groove 66 two balls 67 are located diametrically opposite each other at the different sides of the annular ledge 65. During rotation of a shaft 62, each ball 67 runs over its raceway formed by a annular ledge 65 and opposite walls of a groove 66 thereby causing wobbling movement of a plate 43. The mechanism also operates in the opposite direction, i.e. wobbling movement of a plate 43 will cause the rotation of a shaft 62. It is necessary to note, that unlike a swash plate in the disclosure of application WO8201043 which transfers effort only in one half-cycle of wobbling, the above mechanism operates in both half-cycles. The shaft 63 is connected to the wobble plate 43 by mechanism transferring its rotation irrespective of wobbling movement. In this embodiment, transferring mechanism represents a bevel gear 68. The third shaft of the speed converter is the case of transmitting unit with a groove 44 on the side surface. Hollow shaft 64 is set on a shaft 62 by means of the bearing 69. A shaft 63 is aligned between shaft 62 and 64 by means of bearings 70 and 71. By numeral 72 there is designated a thin-walled separator which is necessary in individual transmitting units to hold balls at identical angular distance from each other in that locus where tangents to grooves in the place of their intersecting are parallel each other (in points B and D at FIGS. 23, 25 and 27). The separator follows the form of conjugated surfaces, i.e. also is a spherical belt. Sockets of the separator 72 are formed as through apertures. Here it is necessary to note, that a separator is a necessary element only for individual variants of transmitting unit. In particular, a separator is not necessary for transmitting units with the high gear ratio and with high accuracy of manufacturing of groove. The converter represents the differential mechanism with two inputs and single output. In the reducer mode the input of converter is the shaft 62, one revolution of which causes one full wobbling of plate 43. If one of shafts 63 or 64 is fixed, i.e. connected to the frame of drive mechanism, then other shaft will be output. If one of shafts 63 or 64 rotates with the speed differing of that of input shaft, then output speed will depend on a ratio of speeds at inputs. In a mode of the multiplier any of shafts 63 or 64 should be input.

Let us consider functioning of the converter in a mode of a reducer. For concrete definition assume the shaft 64 is connected to frame. Input shaft is the shaft 62, when it rotating, balls 67 are involved in revolving around orbit and cause precession of plate 43. Since the case 42 is immovable, ball 46 interacting with grooves 44 and 45 cause rotation of the plate 43 with the transfer ratio determined by an expression (3). Rotation of a plate 43 is transferred to an output shaft 63 by means of a bevel gear 68. Losses to friction, noise and deterioration are minimal in this transmitting unit as it operates in conditions of pure rolling of balls, it is necessary to note, that the converter with friction-planetary unit will operate as above described, but its transfer ratio will different. The speed converter with the transmitting units according to FIGS. 18 or 30 is supplied with the additional shafts directly connected to parts of a case. Thus the number of possible modes of the converter operation is increased.

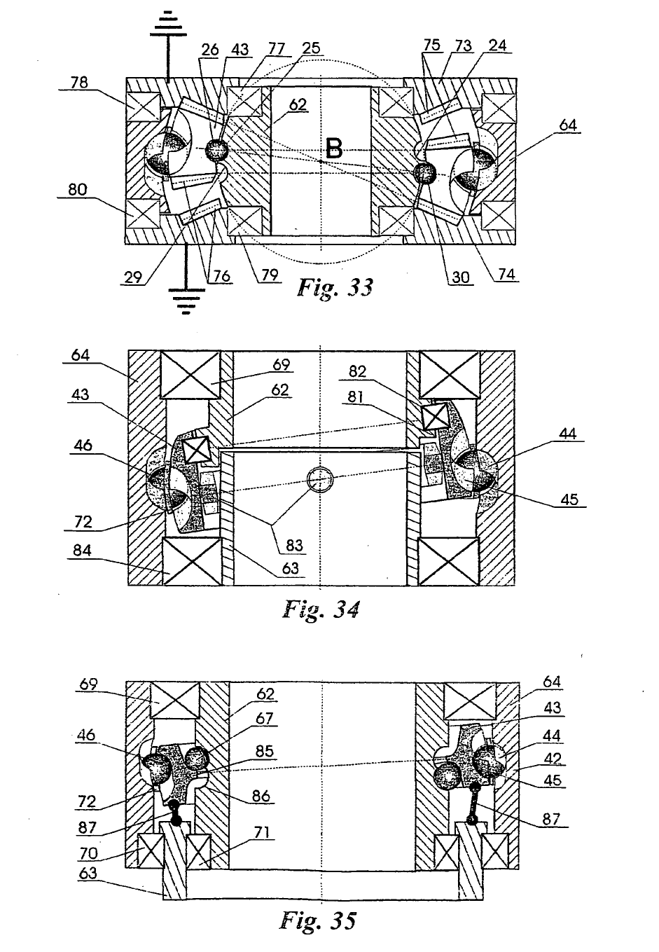

In the embodiment of the converter shown at FIG. 33 the shaft 63 is a non-rotating part and it is formed by two flanges 73 and 74 connected with each other and with a frame. The wobble plate 43 is connected to flanges 73 and 74 by means of two face tooth gearings 75 and 76. Use of two tooth gearings as the mechanism transmitting rotation raises a number of tooth being in driving engagement and increases the transmitted moment. Shafts 62 and 64 are mounted in flanges 73 and 74 by means of bearings 77, 78, 79, 80. The mechanism transferring wobbling of a plate 43 to rotation of a shaft 62 and on the contrary is the coaxial friction-planetary transmitting unit similar to that represented on FIG. 10. There two ring grooves 24 and 29 in a shaft 62 engage with a groove 25 in a wobble plate 43 by means of two balls 26 and 30. Instead of this unit any of above coaxial friction-planetary units may be used.

Variants of converters at FIGS. 34 and 35 differ from each other in both design of mechanism transferring rotation of a shaft 62 into wobbling of a plate 43 and design of mechanism transferring rotation of a wobble plate 43 to a shaft 63 irrespective of wobbling. In the converter at FIG. 34 the first of the transferring mechanisms is embodied on the basis of a skew crank 81 set on a shaft 62. The wobble plate 43 is mounted by means of the bearing 82 on the skew crank 81. For transfer of effort from a skew crank by both half-cycles of the plate 43 wobbling, the bearing 82 is embodied as the annular four-point bearing. The mechanism transferring the rotation represents gimbals joint 83 by means of which the wobble plate 43 is connected with hollow shaft 63. Bearings 69 and 84 align shafts 62, 63 and 64 from each other. The mechanism transferring wobbling movement of a plate 43 to rotation of a shaft 62 at FIG. 35 is similar to the mechanism at FIG. 32, only that the annular ledge 85 is made on the plate 43, and annular groove 86 is made in the side surface of a shaft 62. As the mechanism transferring the rotation at FIG. 35, the system of flexible rods or hinges 87 which allows wobbling of plate 43 irrespective of rotation of a shaft 63 is used.

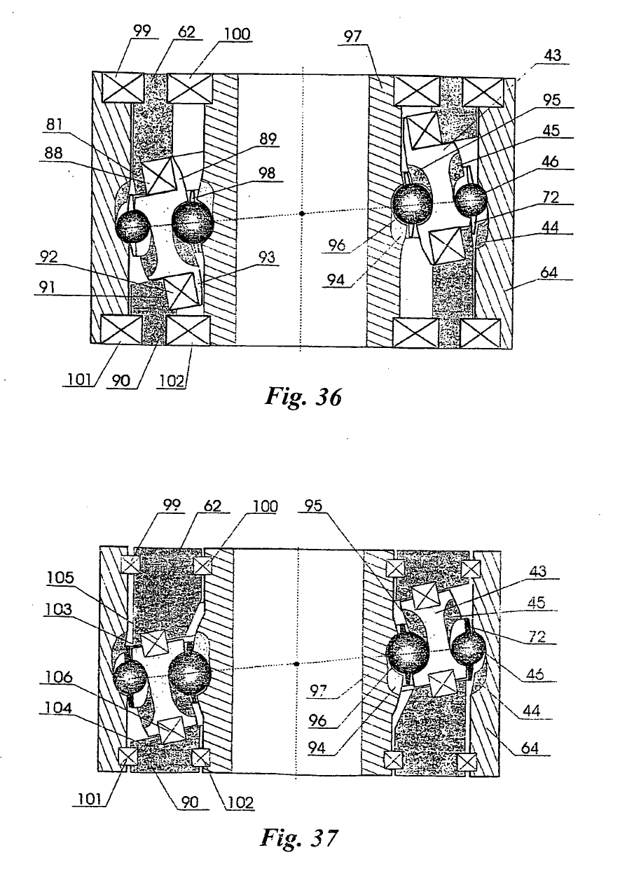

In two-stage coaxial speed converters at FIGS. 36 and 37, transmitting units of both stages are realized by means of single wobble plate 43. One of the transmitting units is formed by periodic grooves 45 and 44 on side surfaces of the wobble plate 43 and the hollow shaft 64 being a case of transmitting unit, and also by a file of balls 46. The mechanism transferring rotation of a shaft 62 into wobbling of the plate 43 represents a skew crank 81 on which through the annular four-point bearing 88 the wobble plate 43 is mounted by shoulder 89. For reliable set of the wobble plate the similar shaft 90 with skew crank 91 is introduced at the opposite end face of the converter. On the shaft 90 through the same bearing 92 the opposite end face of a plate 43 is set by shoulder 93. Transmitting unit of the second stage is formed by periodic grooves 94, 95 and by a file of balls 96. The groove 95 is made in the side surface of the plate 43 opposite to a surface with a groove 45 of the first transmitting unit. The groove 94 is made in the side surface of the hollow shaft 97 faced to a wobble plate 43. Separators of transmitting units of both stages are designated by numerals 72 and 98. Shafts 62, 64, 90 and 97 are combined into united junction by means of bearings 99, 100, 101 and 102 located on end faces of the converter. Shafts 62 and 90 rotate as single shaft and cause the wobbling movement of a plate 43.

The variant of the speed converter represented at FIG. 37, differs from the variant at FIG. 36 only by the mechanism transferring the wobbling movement of a plate 43 into rotation of the shaft 62 and on the contrary. The mechanism represents face cams 103 and 104 at the faced to each other end faces of shafts 62 and 90; said face cams interact with end faces of a wobble plate 43 through thrust face bearings 105 and 106. Application of two oppositely laying face cams enables power transferring during both half-cycles of the plate 43 wobbling. By that the described converter favorably differs from converters in the disclosure of application WO8201043, where all mechanisms of a plate wobbling operate only during one half-cycle. The two-stage converter works as follows. When one of shafts, for example, shaft 62 (together with the shaft 90) is rotated by external drive, plate 43 begins to wobble. The rotation of the input shaft is not transferred to a wobble plate, since it is untied with the shaft by bearings 88, 92 or 105, 106. This wobble movement of a plate 43 by means of interacting of grooves 44 and 45 with balls 46 causes rotation of a wobble plate 43 relative to the shaft 64 by angle determined by the period proportion of the grooves 44 and 45. If the condition of self-blocking of balls 46 in grooves 44 and 45 is satisfied, then balls 46 run in grooves without slippage. Transmitting unit of the second stage is formed by periodic grooves 94 and 95 and by balls 96, and it operates similarly, only the input part of it is a wobble plate 43, which simultaneously wobbles and rotates. Thus, for the first stage of the converter, the function of the mechanism transferring rotation of a wobble plate 43 carries out the transmitting unit of the second stage. The output shaft of the converter in this variant is the shaft 97, the rotation speed of which relative to shaft 62 is determined by the rotation speed of the shaft 64 and by the proportion of groove period numbers of the first and the second stages. It is necessary to note, that input or output shafts can be any of shafts 62 (or 90), 64 and 97. Thus, depending on a speed ratio of two input shafts, the converter works as multiplier or reducer (with one of shafts motionless), or as the differential speed converter.

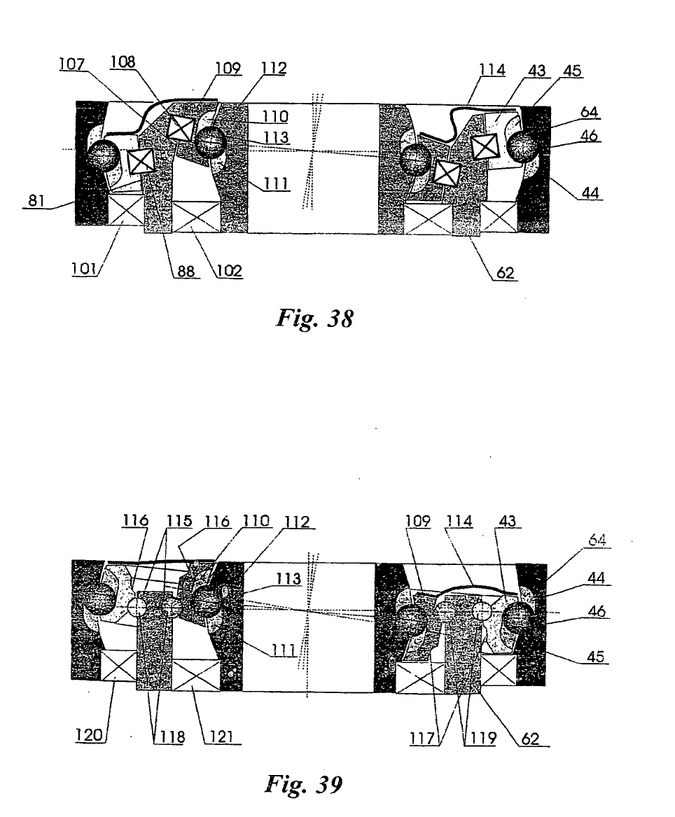

Coaxial two-stage converters at FIGS. 38 and 39 are formed by two transmitting units, male and female. Transmitting unit of the first stage comprises a wobble plate 43 with a periodic groove 45, hollow shaft-case 64 with a groove 44, and a file of balls 46. The mechanism transferring wobbling movement of the plate 43 into rotation of the shaft 62 represents skew crank 81 with the annular four-point bearing 88 on which the plate 43 is set. The opposite side surface of the shaft 62 is provided with skew crank 107, inside of which by means of the same bearing 108 the wobble plate 109 of the second stage is set. At an inner side surface of the plate 109 the transmitting unit of the second stage is realized. It comprises periodic grooves 110 and 111 in the plate 109 and in the hollow the shaft 112, and a file of balls 113. Skew cranks 81 and 107 can have an opposite inclination, as it is shown at FIG. 38, or they can have identical inclination. Accordingly, plates 43 and 109 wobble with opposed phases or synchronously. The first variant is more preferable, as there the wobble plates are weight balanced relative to an axis of the converter. The plates 43 and 109 are connected with each other by means of mechanism transferring rotation irrespective of their wobbling movement. At FIGS. 38 and 39 this mechanism represents a flexible ring 114. At FIG. 38 the shafts 62, 64 and 112 at their end faces are connected by bearings 101 and 102.

The converter at FIG. 39 differs by mechanisms transferring wobbling movement of plates 43 and 109 to rotation of the shaft 62. These mechanisms are formed as friction-planetary transmitting units with grooves 115 at opposite side surfaces of the shaft 62, two parallel to equator grooves 116 and 117 made in both wobble plates, and two pairs diametrically opposite balls 118 and 119 in these grooves. By numerals 120 and 121 the bearings are designated by means of which shafts 62, 64 and 112 are fixed relative to each other.

The operating of these two-stage converters is similar to previous that.

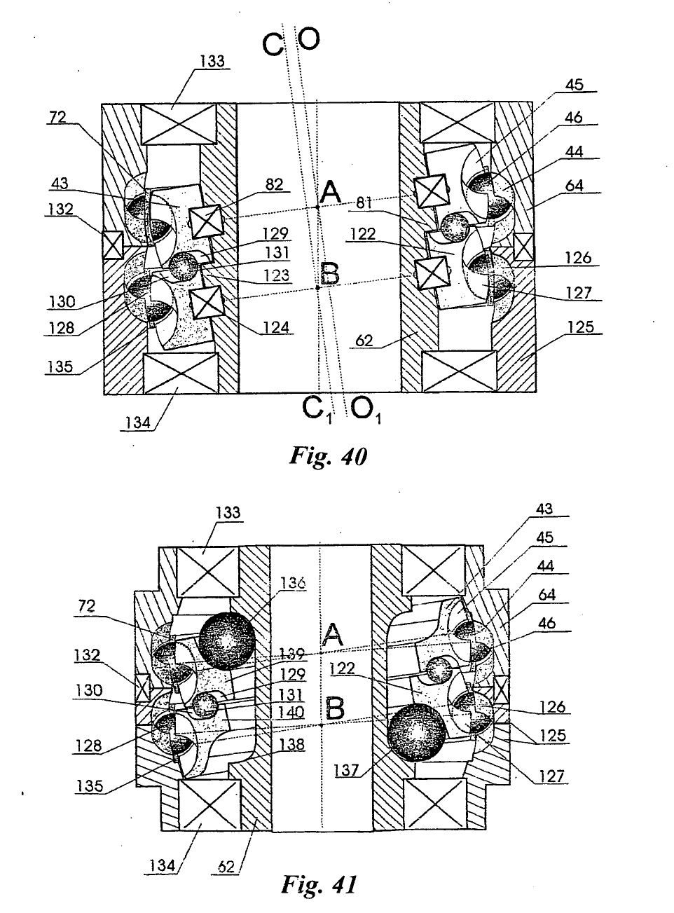

In the two-stage converter with a stages arranged in series at FIG. 40, the transmitting unit of the first stage is formed by a wobble plate 43 and by shaft-case 64 with balls 46 in grooves 44, 45. The unit of the second stage is formed by a wobble plate 122 set at second skew crank 123 on the shaft 62 by means of annular four-point bearing 124. The plates 43 and 122 are parallel each other. A hollow shaft 125 embraces a plate 122 and is being a case of the second stage. At the faced surfaces of a wobble plate 122 and a case 125 the periodic grooves 126 and 127 are made. A file of balls 128 is located in said grooves. The precession axes OO₁ and CC₁ of the wobble plates 43 and 122 accordingly are parallel each other and are off-center displaced from each other. Therefore mechanism transferring rotation of one plate into another in the given design represents mechanism transferring rotation between parallel shafts in the form of a ball parallel crank. It represents sockets 129 and 130 in the end face surfaces of wobble plates 43 and 122, which sockets are engaging with each other by means of balls 131. The axes of sockets are regular spaced along of a circle of each plate, and the diameters of sockets are more than a diameter of ball 131 by value of displacement axes of wobble plates 43 and 122 from each other when they synchronously precess relative to points A and B. When plates precess, balls 131 running in sockets 129 and 130 allow to plates 43 and 122 to be displaced, but do not allow them to rotate relative each other. Thus, the rotation of one of plates causes the rotation of another, thus the balls 131 allow surfaces of plates to be displaced from each other, while keeping an opportunity of their precession relative to own centre. Hollow shafts 64 and 125 can rotate independently from each other due to presence of bearings 132 between them. All three shafts 62, 64 and 125 of converter are assembled in united node by means of bearings 133 and 134. A separator of the second stage transmitting unit is designated by numeral 135.

The following embodiment of the two-stage converter represented at FIG. 41 differs by the mechanism transferring rotation of the shaft 62 into wobbling movement of plates 43 and 122. This mechanism contains two diametrically opposite balls 136 and 137 which are located between a groove 138 in external side surface of the shaft 62 and annular ledges 139 and 140 of plates 43 and 122. For simplification of assembly, the case 125 is split along of a line dividing the periodic groove 126 into two symmetric parts. The shafts 62, 64 and 125 are incorporated by means of bearings 132, 133, 134.

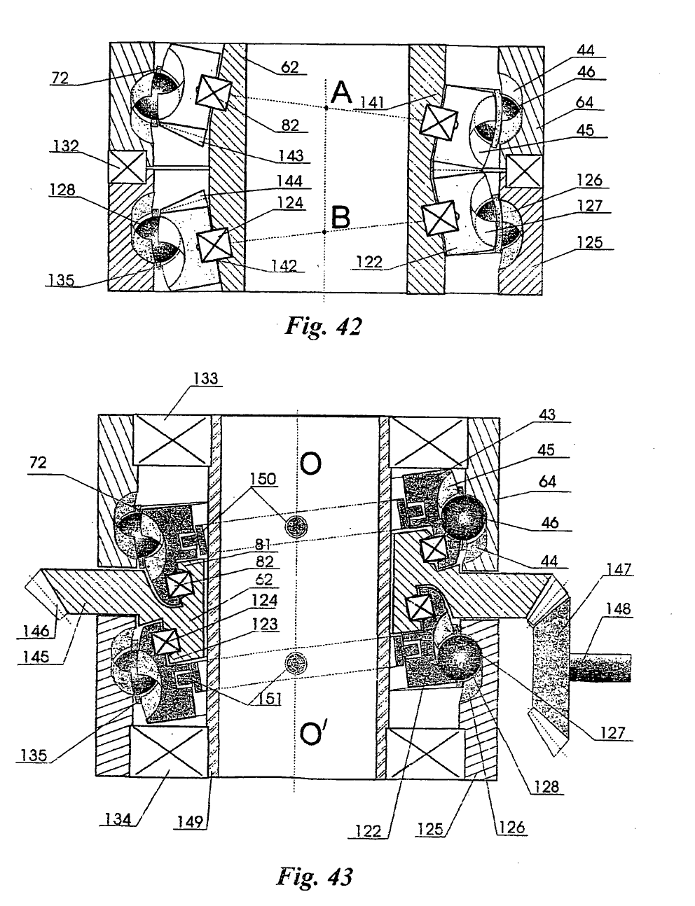

Variant of the two-stage converter shown at FIG. 42 has two wobble plates 43 and 122 wobbling in the opposite phases. For this purpose skew cranks 141 and 142 with an opposite inclinations are provided on the shaft 62. The coupling of cases is carried out by bevel gear wheels 143 and 144. All other designations at FIG. 42 correspond to designations at FIG. 40 and 41.

Two-stage converter at FIG. 43 differs by original designs both the mechanism transferring rotation of the shaft 62 into wobbling movement of plates 43 and 122, and the mechanism transferring rotation between plates 43 and 122 irrespective of their precession. The shaft 62 is formed as a case with skew cranks 81 and 123. at external side surface of said case. Moreover, shaft 62 in the middle part has external annular ledge 145 exceeding the bounds of shafts 64 and 125. External tooth row of annular ledge 145 is formed as a bevel gear wheel 146 engaging a wheel 147 at the shaft 148. Such mechanism transfers rotation between inclined shafts 62 and 148. In this converter the power take-off can be made simultaneously from cases 64 and 125, therefore the converter is very effective as a reducer of the automobile back axle. Hollow shaft 149 coupled to plates 43 and 122 by means of two gimbals joints 150 and 151 passes through internal cavities of the shaft of 62 and wobble plates 43 and 122. Gimbals joints 150 and 151 allow free wobbling of plates 43 and 122 while transferring rotation from each other. Numerals 133 and 134, as well as in the previous Figures, designate bearings connecting elements of the converter with each other.

Two-stage converter with arrangement of stages in series operates in the following way. Assume that the shaft—case 64 of first stage is motionlessly fixed. The rotating of the shaft 62 with angular velocity ω₁ causes the precession of wobble plate 43 with the same velocity. When precessing, the wobble plate 43 forces balls 46 and causes their running without slippage in immovable groove 44 of the case 64 with velocity ω₂ depending on period number of this groove. The running of balls 46, in turn, causes the rotation of a plate 43 relative to a file of balls, which rotation depends on period number of the groove 45 in the wobble plate 43. The wobble plate 43 rotates relative to immovable case 64 with angular velocity ω₃ being the function of period numbers of groove 44 in the case 64 and groove 45 in the plate 43. The rotation of the wobble plate 43 is transferred to the wobble plate 122 by means of either parallel crank balls 131 or teeth of wheels 143 and 144 or shaft 149 with gimbals joints 150 and 151. The wobble plate 122 simultaneously is in rotation and in precession with angular speed ω₁. The balls 128 of the second transmitting unit interacting with both a groove 126 in the plate 122 and a groove 127 in the case 125 cause rotation of the last relative to plate 122 by an angle determined by the ratio of the period numbers of grooves 126 and 127. The total rotation of the driven shaft—case 125 depend on angular velocities ω₁, ω₂, ω₃ and, at the end, it is determined by numbers of the periods of all four grooves in wobble plates and in cases of transmitting units both stages. If the shaft 64 rotates, i.e. it is the second input shaft; output velocity depends, among other things, also on the ratio of input velocities of shafts 62 and 64. The precession center of a file of balls 46 is the point A, and the precession centre of a file of balls 128 is the point B. These centers A and B coincide with the symmetry centers of the appropriate plates. That is, the precession of each file of balls is occurs relative to a point lying in a plane of this file, that considerably simplifies the requirements to a groove contour.

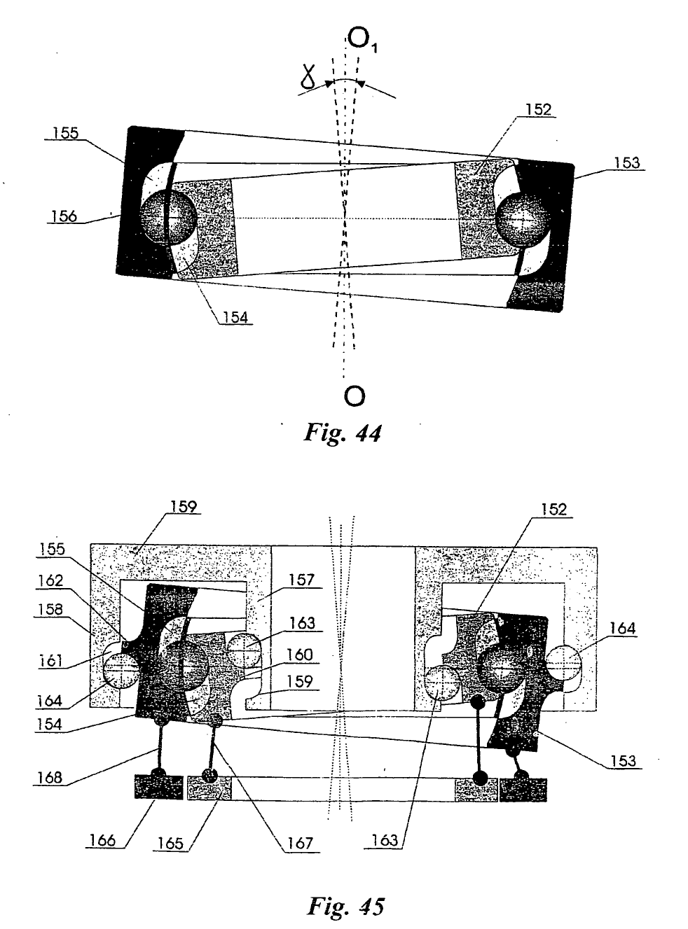

Let us address now to FIG. 44 at which transmitting unit is represented in which two cases 152 and 153 are able to precess and so they are wobble pates. Just as in transmitting unit at FIG. 20, in the faced side surfaces of this cases being in the form of a spherical zones, the periodic grooves 154 and 155 are made, at the intersection of this grooves a file of balls 156 is located. In such transmitting unit with a common angle of an inclination between plates equal to γ, the tilting angle of each plate to an axis OO₁ is γ/2. That is, the precession angle of each plate is reduced twice, that creates more favorable conditions for operate of the mechanism exciting the precession of plates, and also for mechanism transferring the rotation.

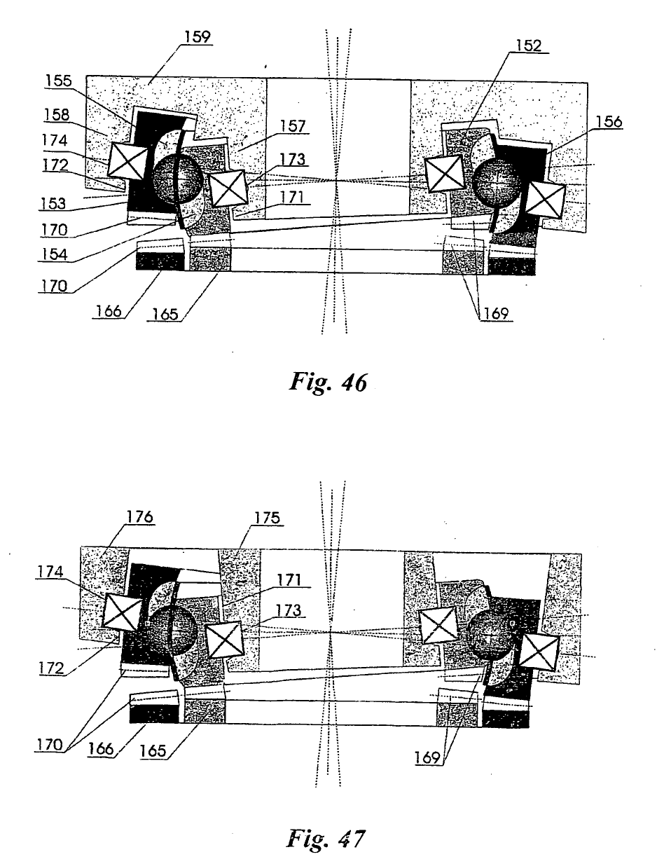

FIGS. 45 and 46 show a schematic drawing of speed converters, in which plates 152 and 153 both wobble by the same angle, but in opposite directions, i.e. precess in opposite phases. The precession is supported by the mechanism in form of two hollow shafts 157 and 158 connected with each other by means of flange 159. The shaft 157 is located inside of transmitting unit, and shaft 158 is located outside of transmitting unit. Closed annular groove 159 and annular ledge 160 are made in the side faced to each other surfaces of the shaft 157 and the plate 152. Similar groove 161 and similar ledge 162 are made in the faced to each other surfaces of other pair composed of shaft 158 and a wobble plate 153. One ball 163 is entered between a wall of a groove 159 and annular ledge 160 at the one hand of plate 152. Other ball 163 is entered between the opposite wall of a groove 159 and opposite side of the ledge 160 at the diametrically opposite hand of a plate. Just as, between a groove 161 and a ledge 162 two balls 164 are entered. The balls 163 and 164 are located relative each other so, that provide an opposite inclinations of plates 152 and 153. The plates 152 and 153 are connected with hollow shafts 165 and 166 by means of mechanisms transferring rotation between misalignment shafts. At FIG. 45 such mechanism is formed as system of levers or flexible rods 167 and 168; and at FIGS. 46 and 47 similar mechanisms are formed as bevel gears 169 and 170.

The mechanism transferring the wobbling of plates 152 and 153 to rotary movement of the shafts 157 and 158 connected with each other shown at FIG. 46 represents two skew cranks 171 and 172 with an opposite inclinations set at the side surfaces of shafts 157 and 158 faced to wobble plates. Wobble plates 152 and 153 are set at the crank shafts 171 and 172 by means of annular four-point bearings 173 and 174.

Operation of speed converters at FIGS. 45 and 46 practically does not differ from operation of the converters represented at FIGS. 33 or 34. One of shafts, 165 or 166 is output part, and another is fixed motionlessly. The power take-off is always made through mechanism transferring rotation between misaligned shafts; and this mechanism is designed for a smaller tilting angle of shafts, than that for the converter with single wobble plate. Moreover, the precession angle of each wobble plates is twice reduced, with other things being equal, i.e. the mechanism transferring wobbling movement of a plate into rotary movement of the shaft and on the contrary operates by smaller angles.

The speed converter shown at FIG. 47 has two independently rotating hollow shafts 175 and 176 provided with skew cranks located inside and outside of transmitting unit. Wobble plates 152 and 153 are set at skew cranks by means of bearings 173 and 174. Crank shafts 175 and 176 form two inputs of the converter and cases 165 and 166 can serve as outputs. If the input shafts rotate with identical velocities and in the same direction and skew cranks have an identical inclination, then plates 152 and 153 wobble without rotation in one direction as a single whole. They will be immovable relative to each other, so the output speeds of the converter will be equal to zero. If the direction one of input shafts is changed to opposite, the converter transfers the torque with the gear ratio determined by ratio of the groove period numbers in each wobble plate. Thus, the speed converter gets an addition function of a coupler.

Thus, in the transmitting units with wobble plate described in the application there is no sliding friction between engaging parts, that raises efficiency, reduces noise and deterioration of both grooves and rolling bodies. Various designs of the speed converters with such transmitting units are constructed by a principle of the bearing, i.e. consist of several coaxial cases, each of cases can serve input or output shaft or frame, thereby changing mode of operation and functions of the converter. Each of the described above units can be applied separately or together, forming designs for various applications, without departing from the spirit and scope of the invention.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

1-47. (canceled)

48. A motion transmitting unit with a wobble plate, said motion transmitting unit comprising two members in form of solids of revolution, one of said member is arranged to make two independent movements: wobbling relative to another member and rotation around of an own axis inclined to an axis of other solid of revolution, and said member is a wobble plate, on the members surfaces faced to each other endless annular grooves are made interacting with each other by means of rolling bodies being in continuous contact with said grooves, and the tilt angle of a wobble plate is chosen so that said grooves in a place of contact with rolling bodies are inclined with respect to each other by angle less or equal to the angle of self-blocking of rolling bodies.

49. The motion transmitting unit according to claim 1 differing in that said grooves are inclined with respect to each other by angle in the range of 0,1 up to 10 degrees.

50. The motion transmitting unit according to claim 1 differing in that the solids of revolution are formed as disks having on the faced to each other flat surfaces the annular closed grooves contacting with each other by means of single rolling body.

51. The motion transmitting unit according to claim 3 differing in that the rolling body is ball, and the side walls of a grooves are resilient flexing to each other.

52. The motion transmitting unit according to claim 1 differing in that the solids of revolution arc made in the form of a case and a wobble plate where one embraces the other, both having side surfaces faced to each other in the form of a spherical zones with the centre of sphere lying at the precession centre of a wobble plate, the rolling bodies are balls, and both grooves in the wobble plate and in the case are made in spherical zones of this members as systems of closed annular grooves parallel with respect to each other and laying in planes perpendicular to axis of rotation of the appropriate member, and the balls are located in points of intersections of the wobble plate grooves with the case grooves.

53. The motion transmitting unit according to claim 5 differing in that in the system of grooves at least one groove in the case is made in separate independently rotating part of the case.

54. A motion transmitting unit with a wobble plate, said motion transmitting unit comprising two solids of revolution one of which embracing the other, one of which is a wobble plate, and another is a case, both having side conjugated surfaces in the form of spherical zones with the centre of sphere lying in the precession centre of the wobble plate, in equatorial areas of their spherical zones periodical in the azimuth direction grooves are made, at least one of which is endless wavy bent in the axial direction; said grooves engage each other by means of a file of balls located in places of grooves intersections, differing in that said grooves in a places of contact with balls are inclined with respect to each other by angle less or equal to the angle of self-blocking of balls.

55. The motion transmitting unit according to claim 7 differing in that the angle α of inclination of the periodic groove front with respect to equatorial line of the wobble plate and appropriate angle β at the case are in the following ratios to the tilt angle γ of the wobble plate: α−β−γ≦10° if α≧β (1); β−α+γ≦10° if α<β.

56. The differential speed converter comprising at least three shafts and the transmitting unit accordingly to any of claims 1-8, differing in that the wobble plate is connected to one of shaft by means of mechanism for independent transferring of its precession motion into rotary and on the contrary, with other of shafts said wobble plate is connected by the mechanism transferring its rotation relative to inclined axis independently of wobbling movement, the second solid of revolution is directly connected to the third shaft.

57. The differential speed converter according to claim 9 differing in that the transmitting unit is formed as claimed in any of claims 5-8, and all shafts are hollow coaxial thereby forming a coaxial design composed of cases just as bearing unit.

58. The differential speed converter according to claim 10 differing in that the transmitting unit is formed as claimed in claim 6 and is supplied with additional shafts, each of which is directly connected to one of the separate parts of the case.

59. The differential speed converter according to claim 10 differing in that the mechanism transferring precession motion of a plate into rotation and on the contrary is formed as claimed in claim 5 and is realized on the same wobble plate at its side opposite to the basic transmitting unit, and the case of said mechanism is directly connected to the first shaft.

60. The differential speed converter according to claim 10 differing in that the coaxial transmitting unit of the second stage is entered in addition, said second stage unit is formed as claimed in any of claims 5-8 and is realized on the same wobble plate of the first transmitting unit at wobble plate side opposite to first transmitting unit, any of said transmitting units carries out the function of the mechanism transferring the rotation of the wobble plate to the shaft directly connected to the case of the second stage transmitting unit.

61. The differential speed converter according to claim 10 differing in that transmitting unit of the second stage is entered in addition being coaxial to First transmitting unit and made as claimed in any of claims 5-8, the second stage transmitting unit is located relative to the first unit so that the wobble plates of both units are faced to each other, the mechanism transferring precession motion of each of plates into rotation is made in the form of hollow shaft entered between said wobble plates of the first and the second stages and having at its internal and external side surfaces elements causing the precession of said plates, and the plates of both stages are connected with each other during rotary movement so that transmitting unit of the second stage simultaneously carries out the function of the mechanism transferring rotation of the wobble plate to the shaft directly connected with the case of the second stage transmitting unit.

62. The differential speed converter according to claim 14 differing in that the elements causing precession of the wobble plates are formed at the side faced to each other surfaces of the hollow shaft and each of wobble plates in the form of annular groove and annular ledge conjugated with each other by means of two diametrically opposite balls located between walls of the groove and ledge at the opposite sides of the last.

63. The differential speed converter according to claim 10 differing in that the transmitting unit of the second stage is entered in series to the first stage transmitting unit, and said second stage transmitting unit is made as claimed in any of claims 5-8, the wobble plates of both stages are connected by the mechanism transferring rotation between parallel shafts, and the mechanism transferring precession motion provides the synchronous precession of plates.

64. The differential speed converter according to claim 10 differing in that the transmitting unit of the second stage is entered in series to the first transmitting unit and formed as claimed in any of claims 7-9, the wobble plates of both stages are connected by the mechanism transferring rotation between inclined shafts, and the mechanism transferring precession motion into rotation and on the contrary provides the precession of the plates in opposite phases.

65. The motion transmitting unit with a wobble plate according to claim 7, differing in that both cases are mounted to precess and are the wobble plates.

66. A differential speed converter comprising at least three axial hollow shafts forming a coaxial design composed of cases just as bearing unit and transmitting unit formed as claimed in claim 18, where in the wobble plates are connected to two shafts by mechanisms transferring rotation between inclined shafts, and said wobble plates are connected to other shafts of the converter by mechanisms for independent transferring of precession motion into rotation and on the contrary.
